(19) United States
(12) Patent Application Publication
(10) Pub. No.: US 2017/0314656 A1
(43) Pub. Date: Nov. 2, 2017

(54) Drive Cable and Drive Unit for a Vehicle Element

(71) Applicants: Webasto SE, Stockdorf (DE); Bekaert Advanced Cords Aalter NV, Aalter (BE)

(72) Inventors: Dominik HOELZEL, Stockdorf (DE); Ulrich SCHREIBER, Stockdorf (DE); Kevin DE CALUWE, Kortrijk (BE); Christophe VERMOERE, Marke (BE)

(21) Appl. No.: 15/521,123

(22) PCT Filed: Oct. 13, 2015
(86) PCT No.: PCT/EP2015/073688

§ 371 Date: Apr. 21, 2017

(30) Foreign Application Priority Data
Nov. 5, 2014 (DE) 10 2014 116 123.8

(51) Int. Cl. F16H 19/06; B60J 7/057; E05F 15/60; F16H 55/26; F16H 19/04

(52) U.S. Cl. CPC F16H 19/0645; F16H 55/26; F16H 19/04; E05F 15/60; B60J 7/0573; E05Y 2900/542

(57) ABSTRACT

A drive cable for actuating a vehicle element which is mobile relative to a vehicle structure, the drive cable having a plastic cable body which has a toothing extending in the axial direction to become engaged with a driving gear wheel and is penetrated by a continuous reinforcement which extends in the axial direction. The toothing is formed by pocket-like recesses which are regularly spaced in the axial direction and are limited by flanks of resulting tooth tips in the longitudinal direction of the cable and by pocket flanks on both sides in the transverse direction of the cable and each of which is limited at the bottom by a tooth root which is penetrated by the continuous reinforcement.

The invention relates to a drive cable for actuating a vehicle element which is mobile relative to a vehicle structure and to a drive unit comprising a driving gear wheel and at least one drive cable of this kind.

Drive cables for actuating a vehicle element which is mobile relative to a vehicle structure are known from practice and serve to actuate a cover element of a sliding roof arrangement, for example, by means of which a roof opening of the vehicle in question can be closed or at least partially opened by choice. The drive cables transmit a driving force from a drive motor to the mobile vehicle element and can be formed of a flexible plastic body which is connected to the vehicle element and has a toothing which is engaged with a driving gear wheel of the drive motor or of a downstream gear mechanism. To provide the plastic drive cable with the necessary stability, the cable body on which the toothing is formed can be penetrated by a reinforcement which extends in the axial direction.

The known plastic drive cables present the problem that either no satisfactory noise behavior can be achieved during operation because the toothing slides against a guiding surface, which, in turn, leads to rattling, or the flexibility in the transverse direction of the cable does not satisfy the requirements applying in connection with a sliding roof.

Furthermore, pressure-resistant drive cables, which are called pitched cables (German: Steigungskabel) and have a pitch helix on their circumference, said helix being engaged with a driving gear wheel of the drive motor in question, are known to be used in practice for driving cover elements of a sliding roof arrangement. Additionally, a flocking is formed on the circumference of the pitched cable. When drive cables of this kind are used, however, the cable may jump in the area of the driving pinion, which, in turn, leads to undesired noise behavior and high wear. Since the circumference of a pitched cable is not homogenous and is additionally provided with the flocking, the pitched cable cannot be guided in corresponding guide tubes without potentially disturbing noise.

The object of the invention is to provide a drive cable having a plastic cable body, said drive cable satisfying high requirements in terms of noise behavior, and to provide a drive unit having a drive cable of this kind.

This object is attained according to the invention by the drive cable having the features of claim 1 and by the drive unit having the features of claim 14.

Thus, the core of the invention is that the cable body is realized in such a manner that the toothing with its tooth tips is arranged in a guide tube or the like in a largely contact-free manner owing the pocket flanks, which reduces the risk of rattling, i.e. of undesired noise behavior. The tooth tips, which can be considered ribs, are thus recessed in the direction of the cable axis relative to a virtually surrounding circumferential surface of the cable body. The continuous reinforcement, which is arranged in the bottom of the recesses, i.e. in the tooth root of the toothing, and which can be made of a recess-free wire or braid, ensures that the drive cable aligns itself properly in its guide, namely with a pretension that prevents rattling. Thus, tooth root is an area of the cable body that is located between two tooth tips.

In the cable according to the invention, the toothing extends along an axial circumferential line of the cable body. The tooth-free portions of the circumferential surface, which form a continuous, homogenous, and jump-free profile surface in the longitudinal direction of the cable, can be used for guiding. In general, the cable body is free of flocking.

Consequently, the drive cable according to the invention is a polymer cable, which, without flocking, can have low-friction contact with a guiding element, such as a guide tube. Moreover, optimal engagement behavior on a driving gear wheel can be established owing to the flexibility provided by the plastic cable body because a plurality of teeth can engage into the toothing of the cable body simultaneously. The toothing extending along the axial circumferential line unambiguously defines the position of the drive cable in relation to the driving gear wheel. Of course, twisting of the drive cable about its longitudinal axis in the engagement area has to be prevented in order to ensure flawless operation of the resulting drive system.

Advantageously, the cable body of the drive cable according to the invention is an extruded polymer element having a circular or oval cross-section. The toothing or, more precisely, the tooth tips of the toothing are recessed in the direction of the cable body axis with respect to a circumferential surface defined by the cable body in the tooth-free portion and virtually continued in the toothed portion, the toothing thus being located entirely within the guiding surface formed by the cable body circumference. Consequently, the basic radius of the cable body is larger than the maximum radius of the tooth-tip end faces with respect to the geometrical center axis of the cable body. Thus, contact between a cable guide and the toothing can be prevented, which, in turn, is favorable in terms of noise behavior when the drive cable is being actuated.

The reinforcement, which can be made in particular of a steel wire or a steel braid, can be arranged eccentrically with respect to the geometrical center axis of the cable body in order to achieve a preferred bending direction of the drive cable according to the invention.

Alternatively, a preferred bending direction of the drive cable according to the invention can be achieved by arranging the reinforcement in the geometrical axis of the cable body and introducing a material weakening in the form of a groove or axial recess at the circumference of the cable body along a defined line.

The eccentric arrangement of the reinforcement or the axial recess can cause additional twisting of the drive cable within a cable guide, the cable thus being arranged in the cable guide with a certain pretension, which, in turn, can prevent undesired rattling. Moreover, a corresponding advantageous arrangement of the reinforcement or of the recess allows the drive cable to automatically align itself correctly on the driving gear wheal without requiring special guiding surfaces on the drive cable because the cable will always align itself in the direction of the lowest geometrical moment of inertia.

To ensure that the ribs of the drive cable formed by the toothing are guided in a contact-free manner in corresponding guides of a drive system, each recess has an opening cross-section that takes up less than 180° of the circumference of the cable body with respect to the circumferential direction of the cable body. This means that the guiding section of the drive cable is formed by a surface of the drive cable that faces away from the recesses and extends in the circumferential direction of the cable body across an area of more than 180° and does so without interruption in the longitudinal direction of the cable.

Each pocket flank has a pocket side edge. A guiding section of the cable body thus extends between the two pocket side edges of a recess.

In a special embodiment of the drive cable according to the invention, the guiding section of the cable body has at least three guiding surfaces, which are spaced apart from each other in the circumferential direction and curved in the circumferential direction. Plane surfaces or recesses of the cable body can be arranged between the guiding surfaces.

To achieve optimal guiding behavior of the drive cable in a cable guide, the guiding surfaces or, more precisely, axial center lines of the guiding surfaces are offset from each other in the circumferential direction by about 120°.

In order to exactly define the position of the cable body or its rotational position in the installed state, the cable body can additionally have an axial recess on its circumference into which a guiding rib of the cable guide engages. In particular, the recess can also be formed by a flattened portion of the cable body, said flattened portion being in contact with a corresponding support surface of the cable guide. A rib can be formed as well on the circumference of the cable body, said rib engaging into a groove of the cable guide.

The invention also relates to a drive cable for actuating a vehicle element which is mobile relative to a vehicle structure, the drive cable comprising a plastic cable body which has a toothing extending in the axial direction to become engaged with a driving gear wheel and is provided with a tapering end on which an entry track for the driving gear wheel is formed, the entry track extending in the longitudinal direction of the cable and being limited by entry flanks on both sides in the transverse direction of the cable and extending in the longitudinal direction of the cable up to a tooth tip of the toothing.

The design according to the invention allows the drive cable to be pushed up to the driving gear wheel during mounting without any problems and with accuracy of position in terms of its rotational position. Actuation of the driving gear wheel will thus immediately cause the driving gear wheel to engage into the toothing of the drive cable because one tooth of the driving gear wheel is already in contact with a tooth tip of the toothing of the cable body.

In order to not have to overcome mechanical resistance when introducing or approaching the drive cable to the driving gear wheel, the entry track preferably has a bottom that is flush with a tooth root of the toothing.

In a special embodiment of the drive cable according to the invention, the toothing is close enough to the front end of the cable body for the entry track to be formed by a tooth root of the toothing itself. The entry track can be limited to the axial width of a tooth root.

Furthermore, the invention relates to a drive unit for a vehicle element which is mobile relative to a vehicle structure, the drive unit comprising a driving gear wheel and at least one drive cable according to the kind described above.

To prevent teeth from jumping in the engagement area between the drive cable and the driving gear wheel, these two elements are engaged across a contact line following a circular line in a preferred embodiment of the drive unit according to the invention. This ensures at all times that multiple teeth of the driving gear wheel engage into the toothing of the drive cable.

In a special embodiment of the drive unit according to the invention, the contact line extends across at least 30° with respect to the circumference of the driving gear wheel. It is also contemplated for the contact line to extend across 180° and more.

In another special embodiment of the drive unit according to the invention, the driving gear wheel is engaged with to drive cables of the kind described above, the two drive cables being offset from each other in the axial direction of the driving gear wheel. In this case, the driving gear wheel preferably has two toothings spaced apart from each other in the axial direction, each of which is associated with one of the two drive cables. A wrap angle of about at least 180° can be realized in particular in case of drive cables that are engaged with the driving gear wheel in different planes.

Other advantages and advantageous embodiments of the subject-matter of the invention are apparent from the description, the drawing and the claims.

Embodiments of drive units according to the invention and of drive cables according to the invention are illustrated in the drawing in a schematically simplified manner and will be explained in more detail in the following description. In the drawing:

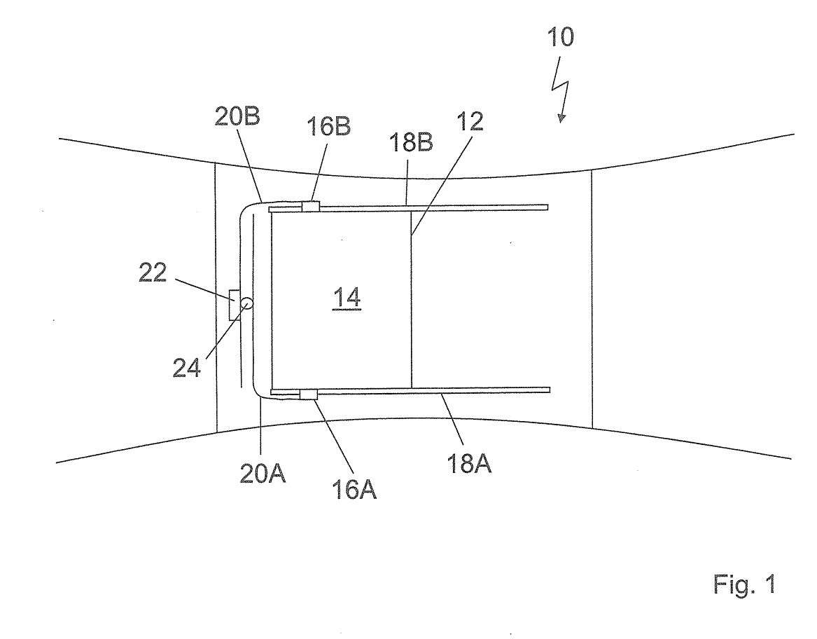

FIG. 1 shows a schematic top view of a vehicle roof having a drive unit for a mobile cover element;

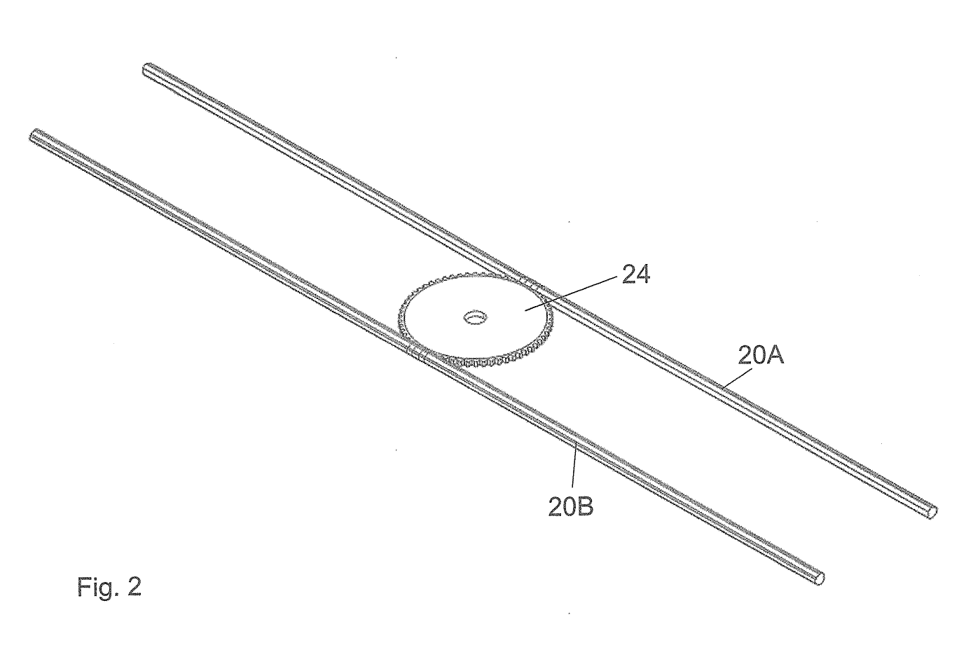

FIG. 2 shows an enlarged view of a driving gear wheel and two drive cables of the drive unit;

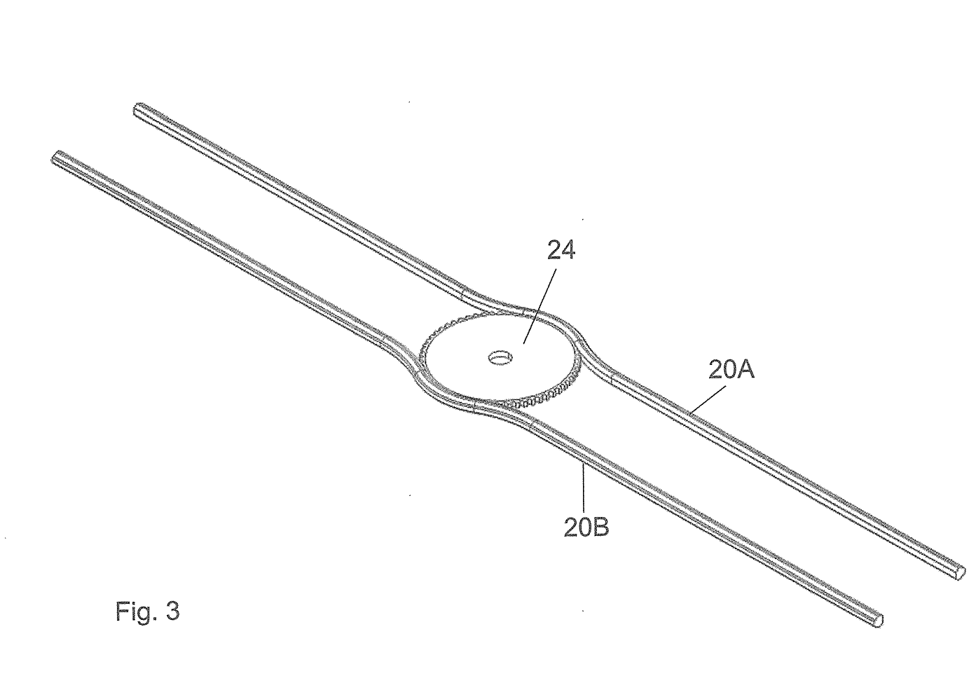

FIG. 3 shows an alternative embodiment of an engagement of a driving gear wheel into two drive cables;

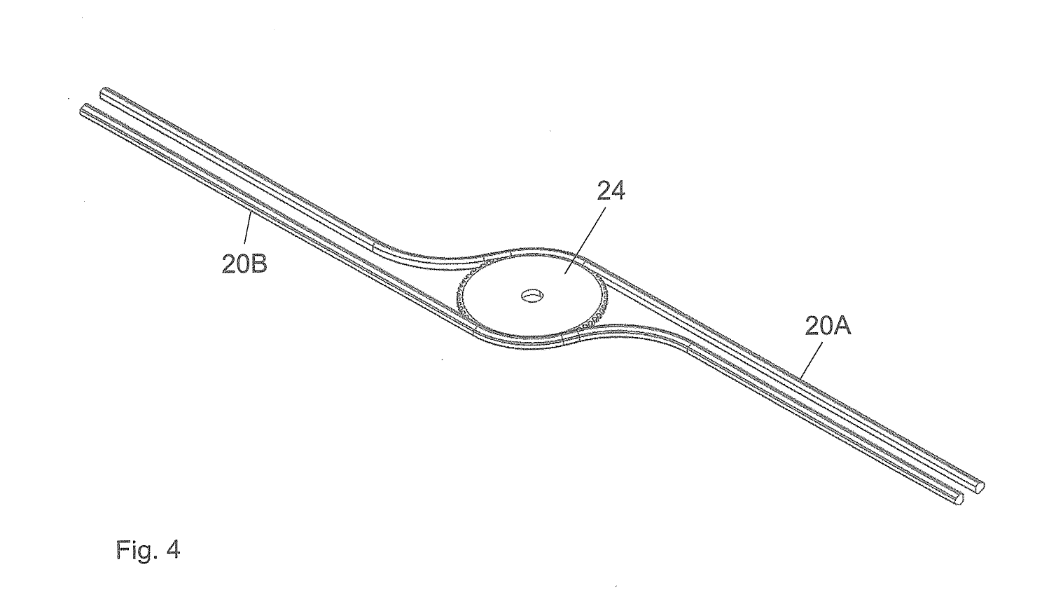

FIG. 4 shows a further alternative embodiment of the engagement of a driving gear wheel into two drive cables;

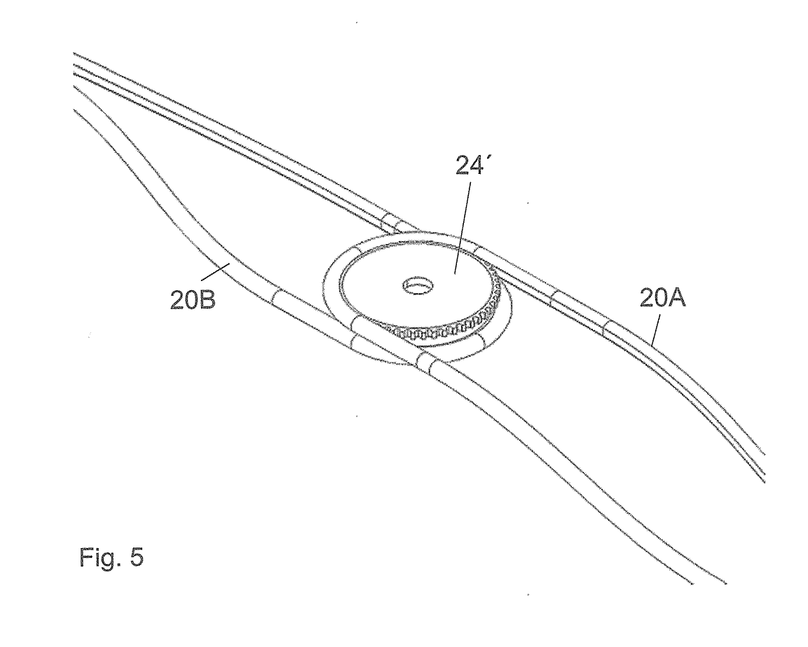

FIG. 5 shows a driving gear wheel and two drive cables engaged therewith in different planes;

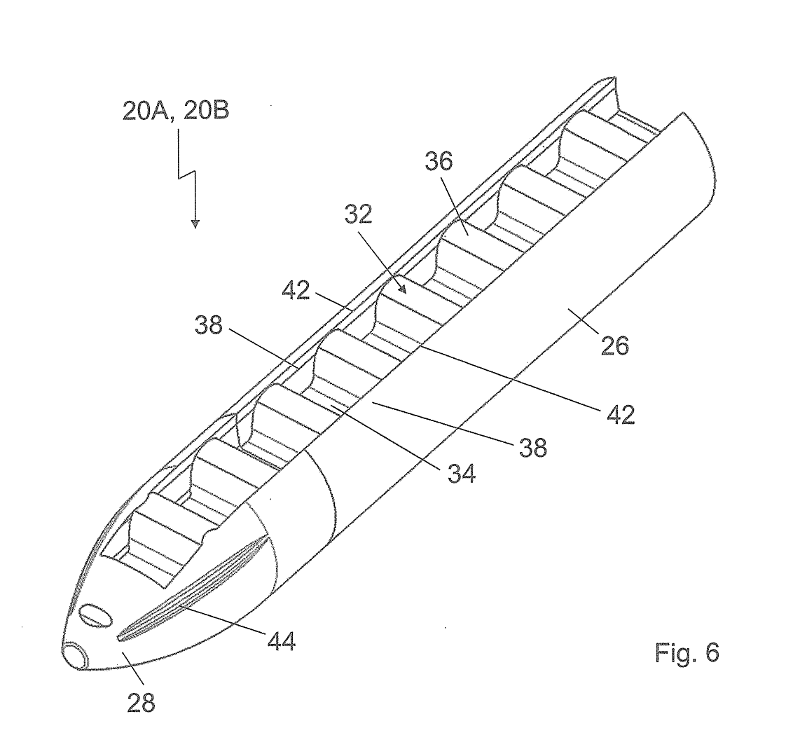

FIG. 6 shows a perspective view of a drive cable;

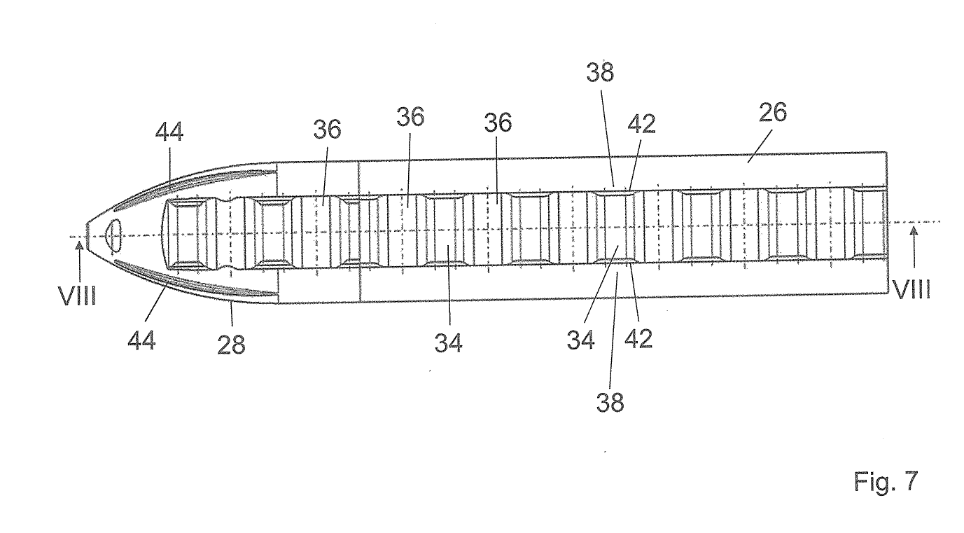

FIG. 7 shows a top view of the drive cable according to FIG. 6;

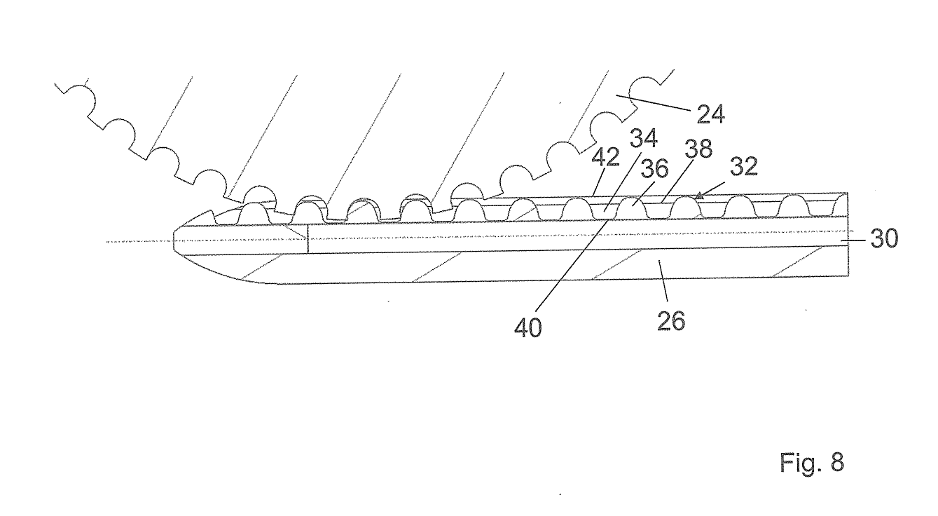

FIG. 8 shows a section through the drive cable along line VIII-VIII in FIG. 7 together with a driving gear wheel;

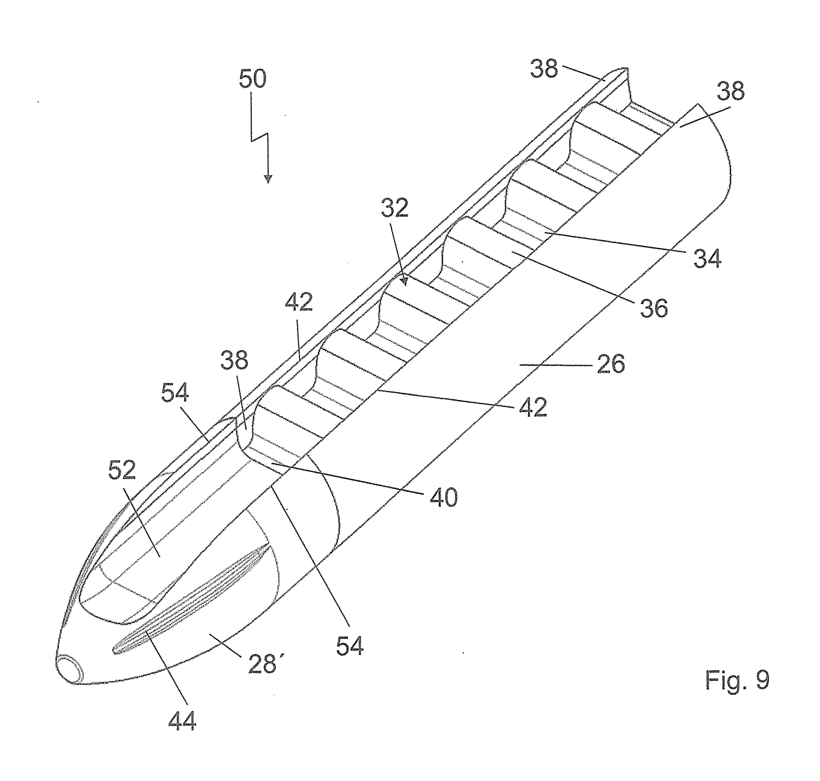

FIG. 9 shows a perspective view of an alternative embodiment of a drive cable;

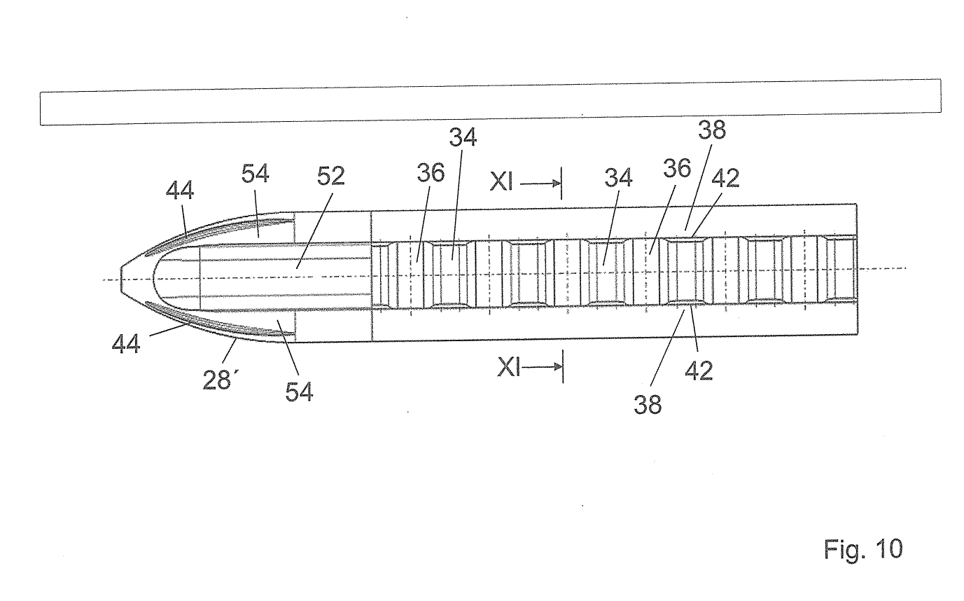

FIG. 10 shows a top view of the drive cable according to FIG. 9;

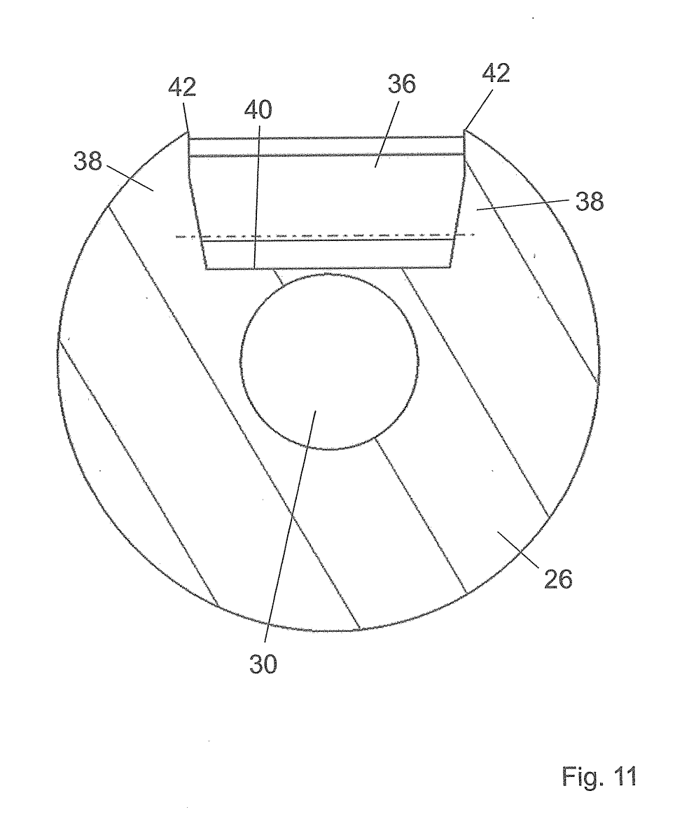

FIG. 11 shows a section through the drive cable along line XI-XI in FIG. 10;

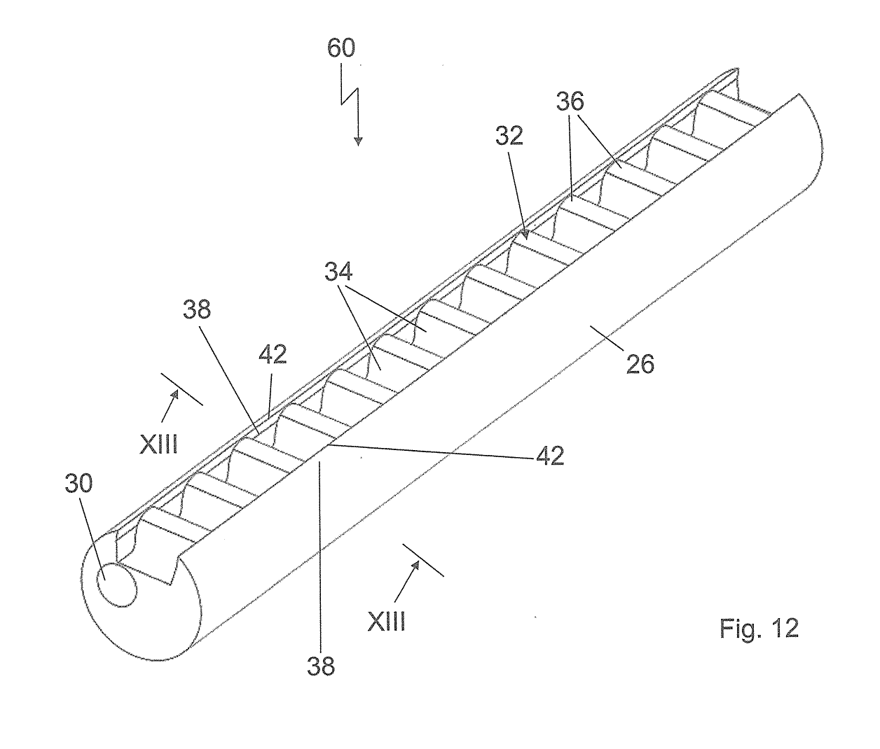

FIG. 12 shows a perspective view of another embodiment of a drive cable according to the invention,

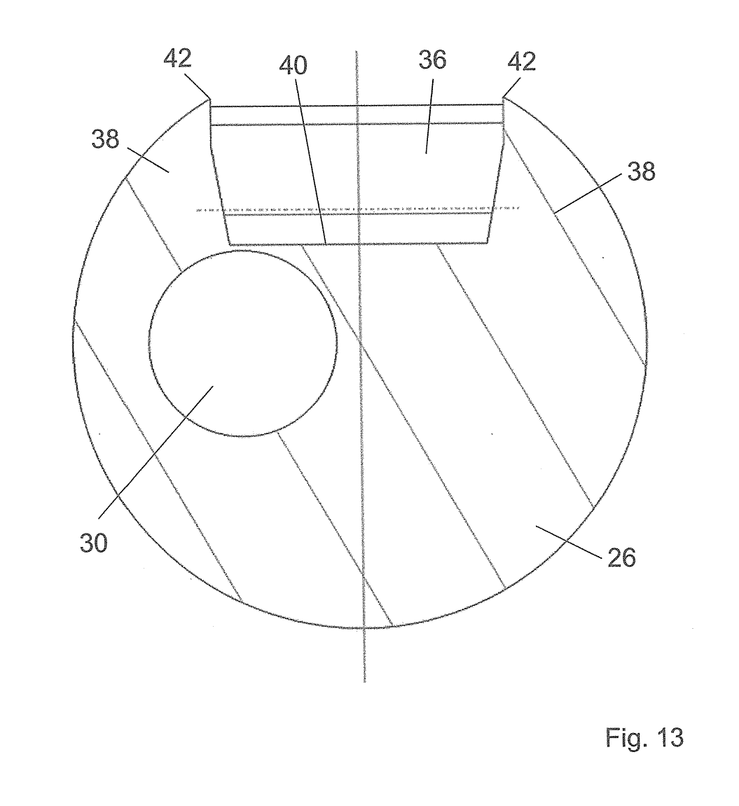

FIG. 13 shows a section through the drive cable according to FIG. 12 along line XIII-XIII in FIG. 12;

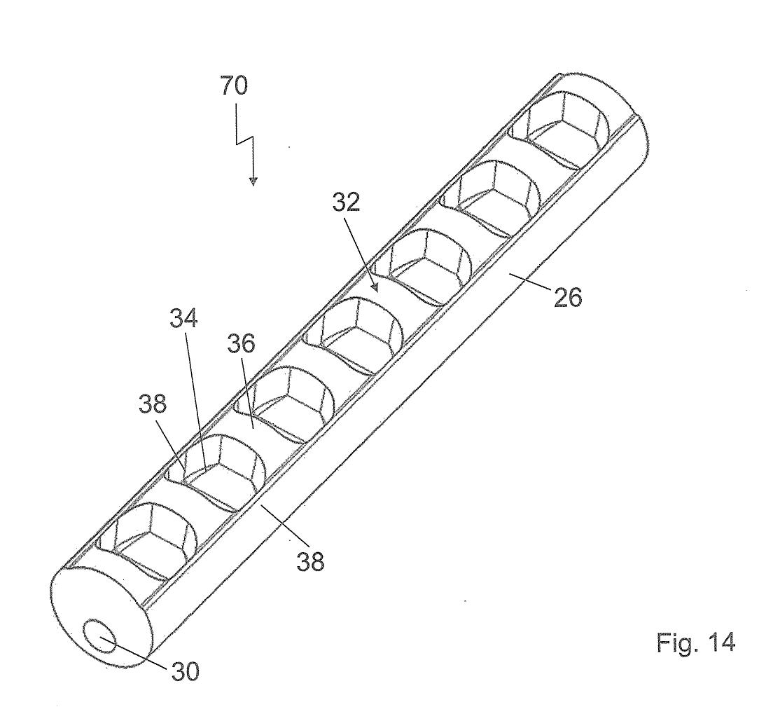

FIG. 14 shows a perspective view of another embodiment of a drive cable according to the invention;

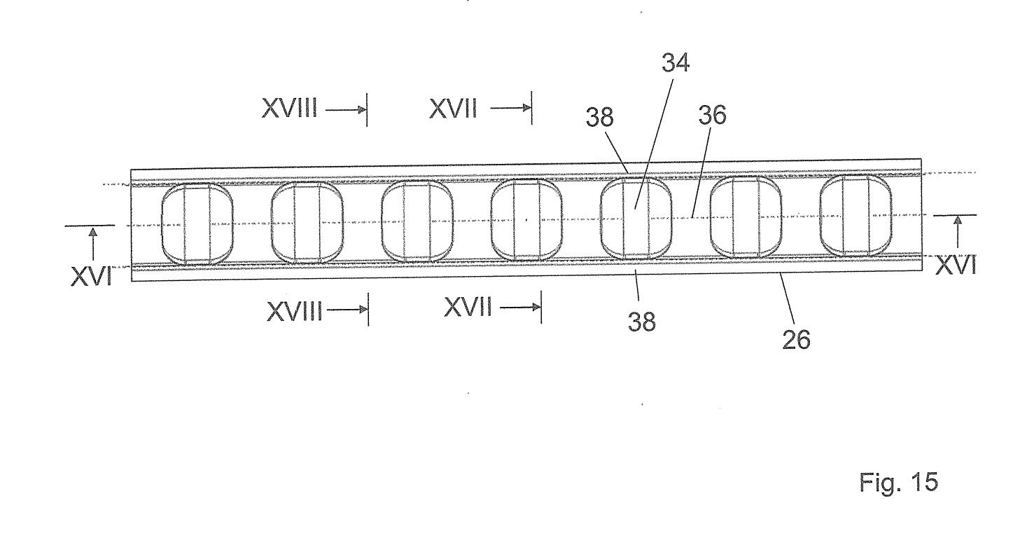

FIG. 15 shows a top view of the drive cable according to FIG. 14;

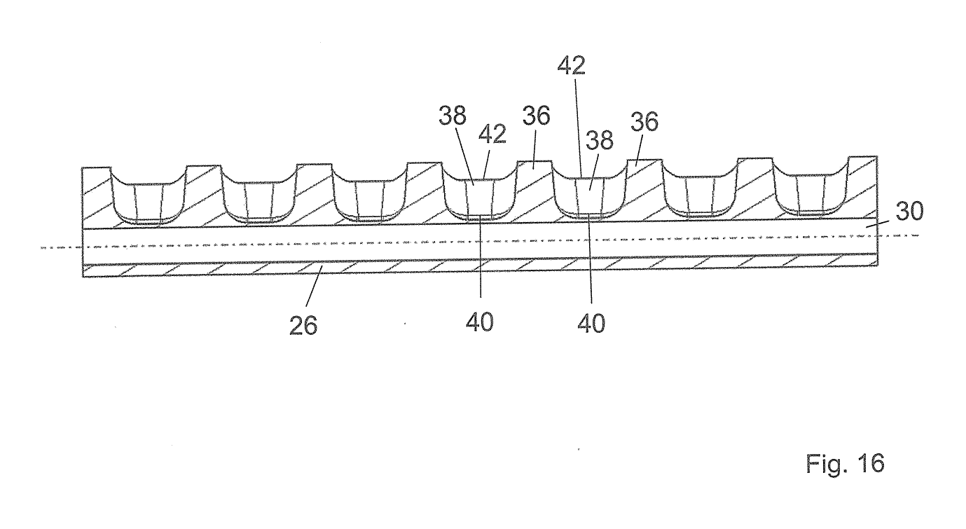

FIG. 16 shows a section through the drive cable according to FIG. 14 along line XVI-XVI in FIG. 15;

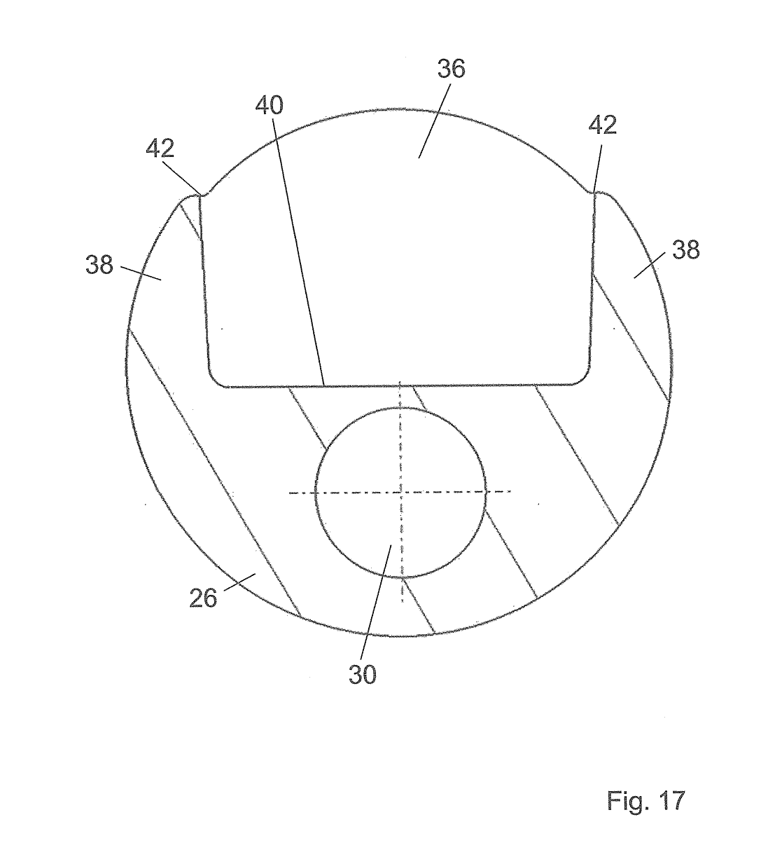

FIG. 17 shows a section through the drive cable according to FIG. 14 along line XVII-XVII in FIG. 15;

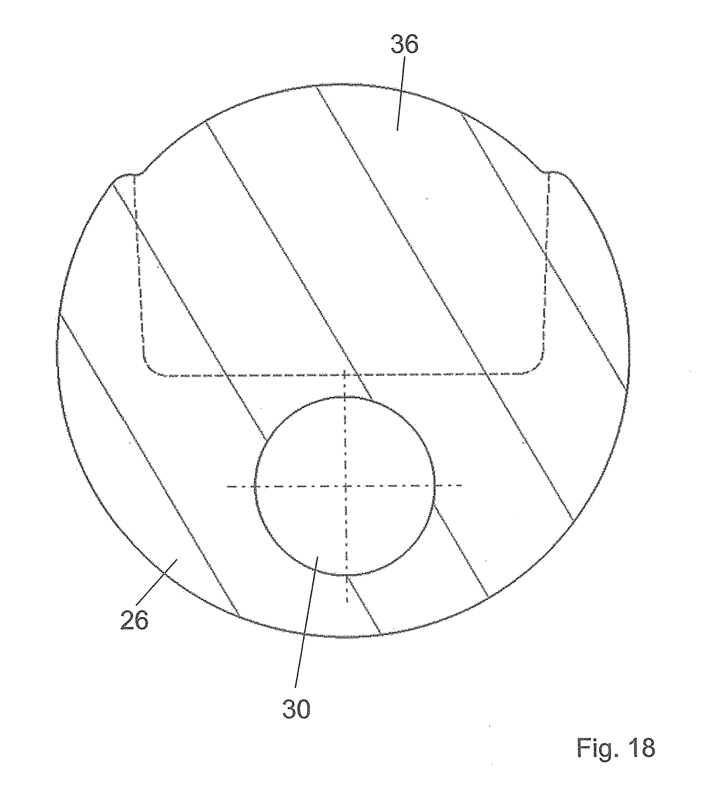

FIG. 18 shows a section through the drive cable according to FIG. 14 along line XVIII-XVIII in FIG. 15;

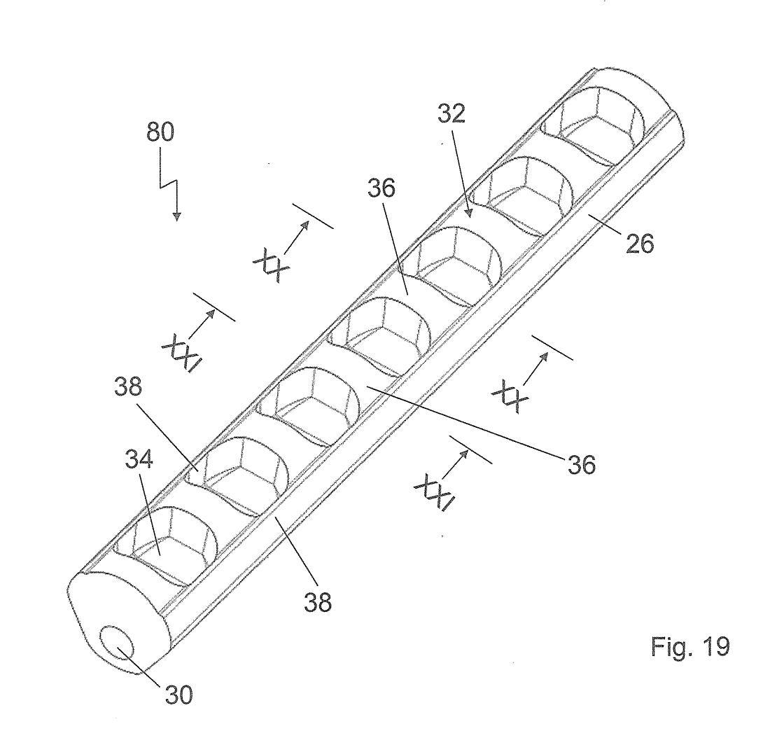

FIG. 19 shows a perspective view of another embodiment of a drive cable according to the invention;

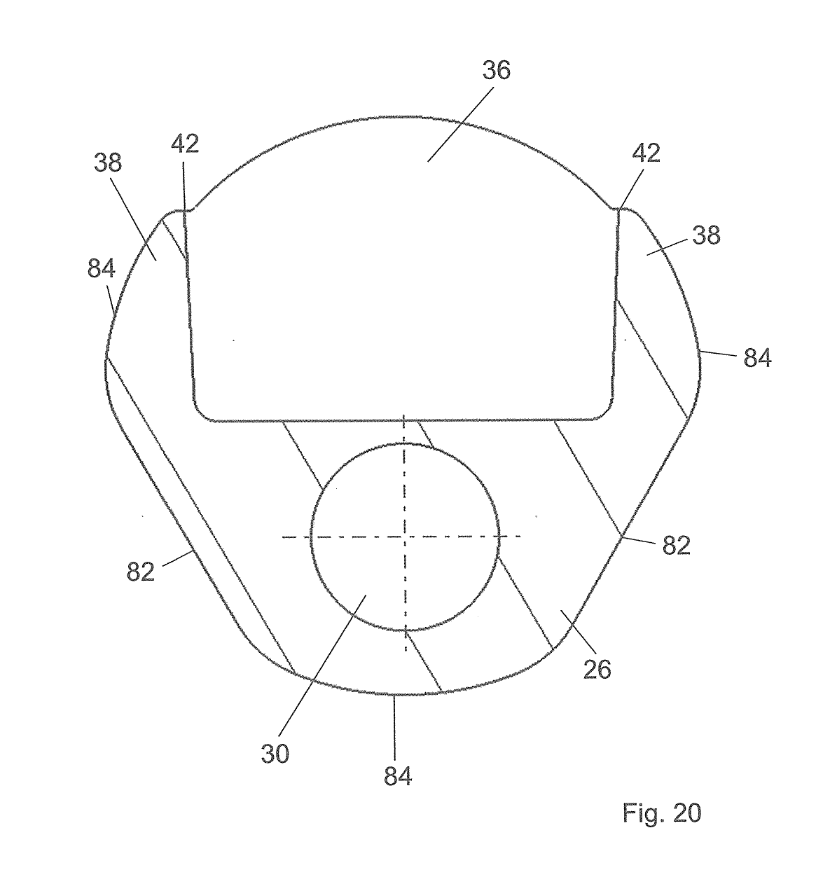

FIG. 20 shows a section through the drive cable according to FIG. 19 along line XX-XX in FIG. 19;

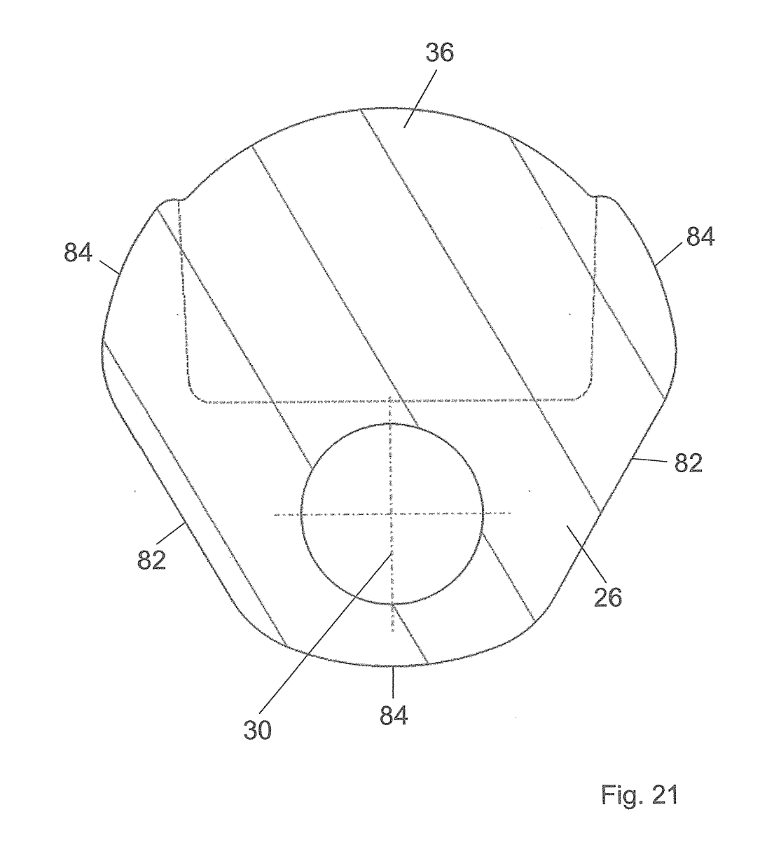

FIG. 21 shows a section through the drive cable according to FIG. 19 along line XXI-XXI in FIG. 19;

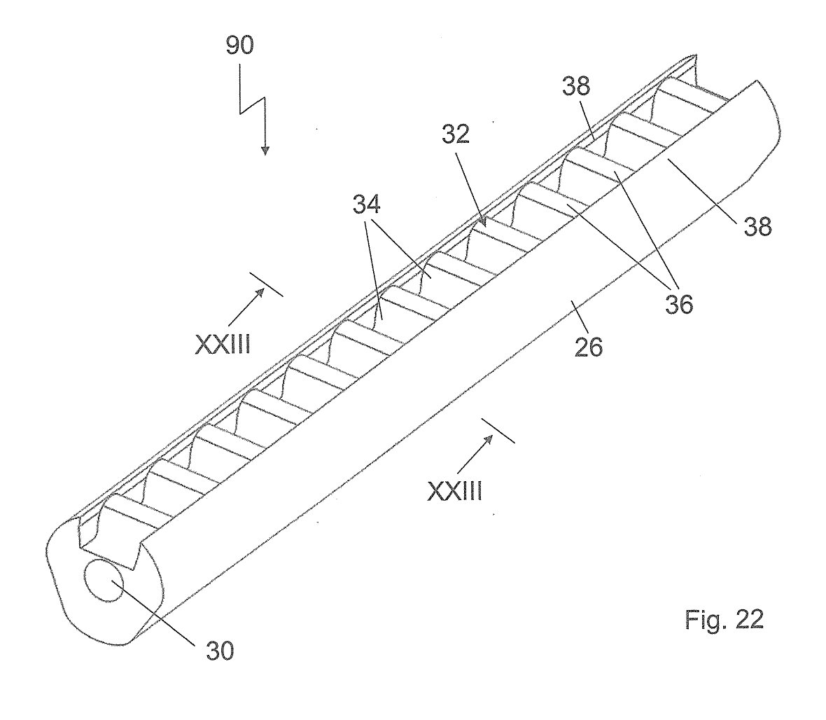

FIG. 22 shows a perspective view of another embodiment of a drive cable according to the invention;

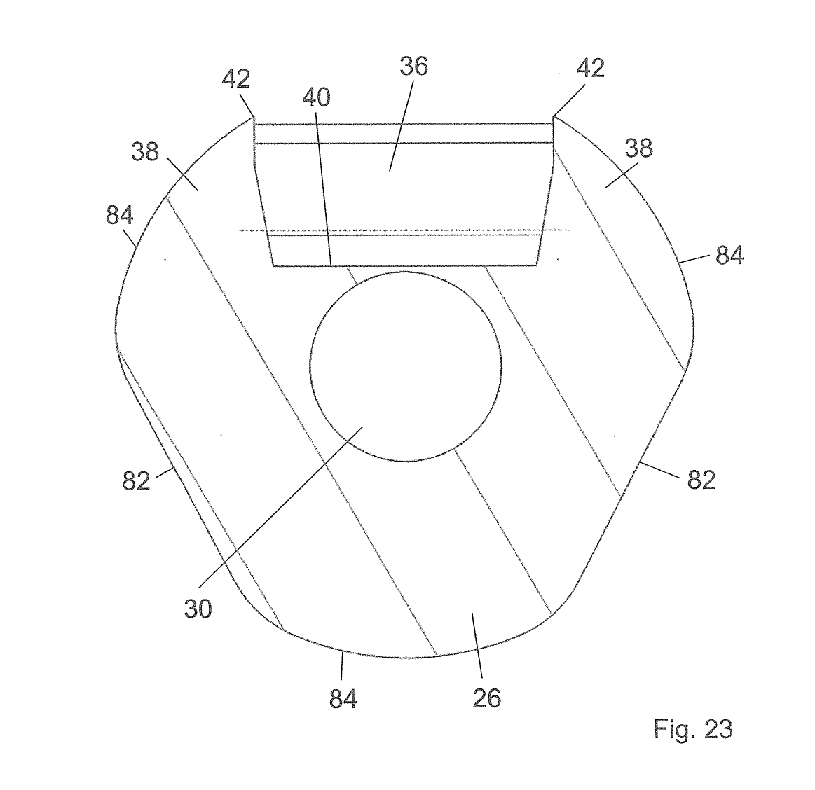

FIG. 23 shows a section through the drive cable according to FIG. 22 along line in FIG. 22;

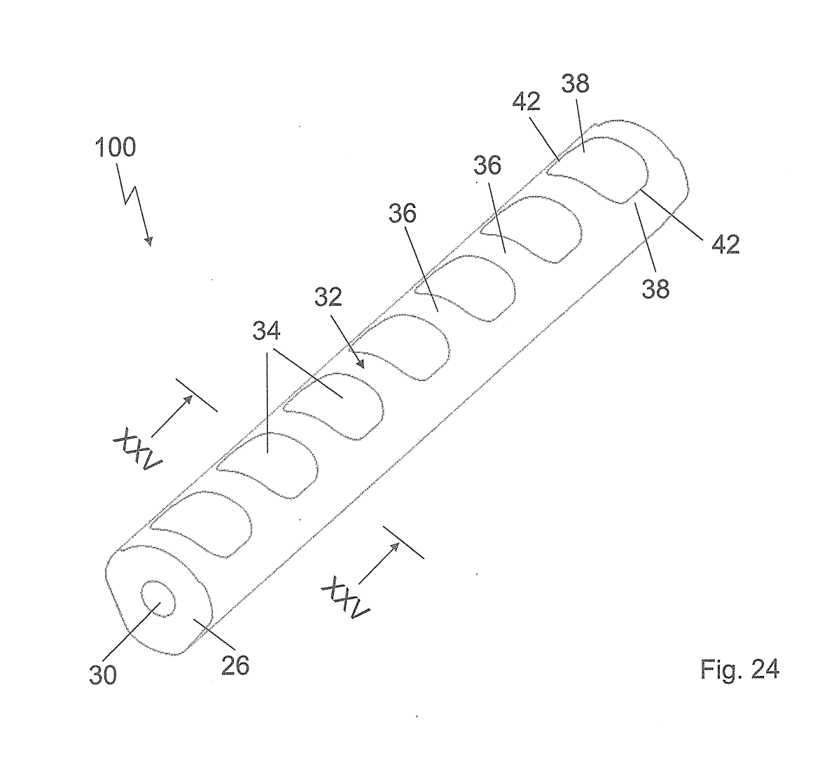

FIG. 24 shows a perspective view of another embodiment of a drive cable according to the invention; and

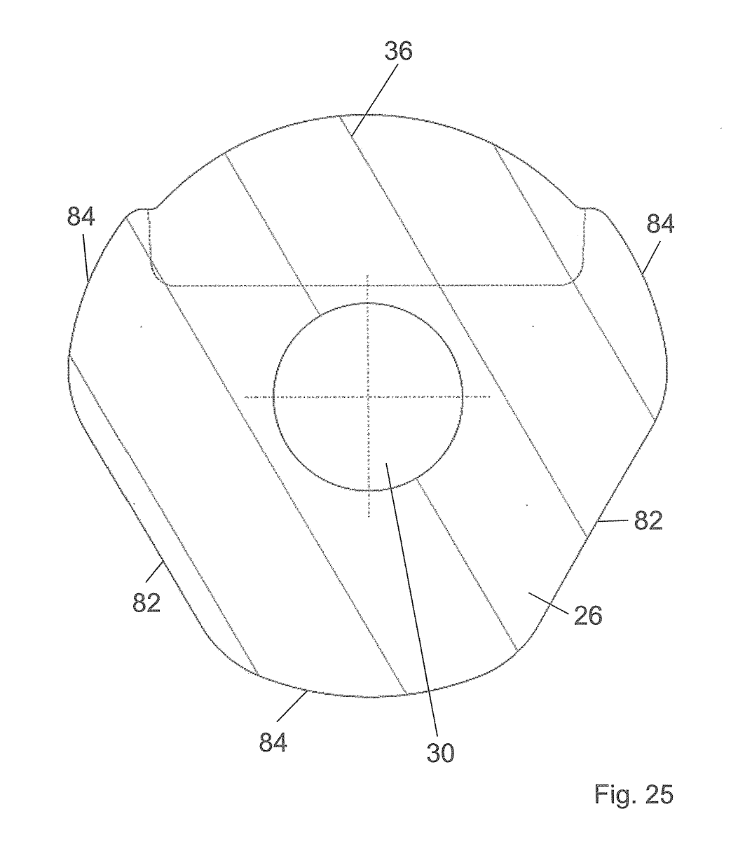

FIG. 25 shows a section through the drive cable according to FIG. 24 along line XXV-XXV in FIG. 24.

FIG. 1 shows a vehicle roof 10 of a passenger vehicle not illustrated otherwise, the vehicle roof 10 having a roof opening 12 which can be closed or at least partially opened by choice by means of a cover element 14. The cover element 14 thus represents a vehicle element which is mobile relative to the vehicle structure.

In order for the cover element 14 to be adjustable, adjustment kinematics are provided that have drive slides 16A and 16B on both sides with respect to a vertical longitudinal center plane of the roof, each drive slide 16A and 16B being guided in a respective guide rail 18A and 18B, respectively, which extends in the longitudinal direction of the roof.

A pressure-resistant drive cable 20A and 20B is connected to each drive slide 16A and 16B, respectively. The drive cables 20A and 20B are guided via corresponding guide tubes toward a shared drive motor 22 and are engaged with a shared driving gear wheel 24 of said drive motor 22. The drive motor 22 and its driving gear wheel 24 and the drive cables 20A and 20B thus form a drive unit for the cover element 14.

In the embodiment illustrated in FIGS. 1 and 2, the drive cables 20A and 20B each run in a straight line in the area of the driving gear wheel 24.

In an alternative embodiment, however, the drive cables 20A and 20B, which each have a cable body made of plastic, can also be engaged with the driving gear wheel 24 across a contact line that follows a circular line, thus ensuring the engagement of multiple teeth of the driving gear wheel 24 into the drive cables 20A and 20B. FIG. 3 shows a drive unit in which the drive cables 20A and 20B are each engaged to the driving gear wheel across a curved contact line, whereas the sections of the drive cables 20A and 20B that are arranged on the load side on the one hand and on the unloaded side on the other hand are aligned with each other.

FIG. 4 shows an embodiment of a drive unit in which the drive cables 20A and 20B are each guided tangentially toward the driving gear wheel 24 on the load side, where they are engaged with the driving gear wheel 24 across a curved contact line, and transition into an exiting straight portion with a contrary curve on the unloaded side. In this embodiment, too, in which the drive cables 20A and 20B run in an S-shape in the area of the driving gear wheel 24, a plurality of teeth of the driving gear wheel 24 is engaged with the drive cables 20A and 20B in each case.

FIG. 5 shows another alternative embodiment of a drive unit. This drive unit comprises a driving gear wheel 24′ that has two toothings axially offset from each other with respect to the axis of the driving gear wheel 24′, each of said toothings being engaged with a drive cable 20A and 20B, respectively. The drive cables 20A and 20B each wrap around the driving gear wheel 25′ in the circumferential direction in an area of about 180°. In this way, secure engagement of the driving gear wheel 24′ into the drive cables 20A and 20B is ensured.

As mentioned above, the drive cables 20A and 20B are realized as plastic drive cables. A drive cable 20A and 20B of this kind is illustrated in detail in FIGS. 6 to 8 and comprises a plastic cable body 26 whose circumference forms a cylinder surface interrupted in the circumferential direction and which has a tapering end portion 28. The cable body 26 forms a circumferential surface of the drive cable 20A and 20B, said circumferential surface extending at an angle of about 270° to 300° in the circumferential direction and forming a guiding section of the cable body 26, said guiding section being interrupted by a toothing 32.

As shown in particular in FIG. 8, the cable body 26 is penetrated by an uninterrupted reinforcement 30, which is made of steel wire and arranged in the neutral fiber or in the geometrical axis of the cable body 26, i.e. centrically with respect to the cylindrical shape of the cable body 26.

The toothing 32 is impressed into the cable body 26, said toothing 32 being formed by pocket-like recesses 34 which are regularly spaced in the longitudinal direction of the cable body 26 and each of which is limited by flanks of resulting tooth tips 36 on both sides in the longitudinal direction of the cable by pocket flanks 38 formed by the cable body 26 on both sides in the transverse direction of the cable. With their bottoms, the recesses 34 each limit a tooth root 40, which is penetrated or undercut by the reinforcement 30.

The pocket flanks 38 each have a pocket side edge 42 in relation to which the rib-like tooth tips 36 are recessed in the direction of the reinforcement 30. This means that a small step is formed between the end face of each tooth tip 36 and the circumference of the cable body 26. By means of the pocket flanks 38 and of the tooth tips 36 being lower than the pocket flanks 38, the tooth tips 36 can be prevented from being in contact with guides of the respective drive cable 20A and 20B, any rattling potentially caused by said contact thus being avoided.

The end portion 28 of the cable body 26 has guiding grooves 44 on both sides, via which the drive cables 20A and 20B can be guided toward the driving gear wheel 24 with accuracy of position with respect to their rotational position, which ensures simple mounting of the resulting drive unit.

In FIGS. 9 to 11, an alternative embodiment of a drive cable 50 is illustrated, which largely corresponds to the drive cable illustrated in FIGS. 6 to 8 but differs from it in an end portion 28′ which has an entry track 52 extending in the longitudinal direction of the cable and allowing the drive cable 50 to be guided toward the driving gear wheel 24 in question with accuracy of position and in a manner ensuring secure engagement during mounting. The entry track has entry flanks 54 on both sides with respect to the longitudinal direction of the cable, said entry flanks 54 being flush with the pocket flanks 38 of the recesses 34 of the toothing 32 that are arranged on the corresponding side. Correspondingly, a bottom of the entry track 52 is flush with the tooth roots 40 of the toothing.

In other respects, the drive cable 50 corresponds to the drive cable illustrated in FIGS. 6 to 8.

In FIGS. 12 and 13, another embodiment of a drive cable 60 is illustrated, which differs from the drive cable according to FIGS. 9 to 11 in that it has a reinforcement 30 which is formed by a steel wire or by a wire braid and arranged eccentrically with respect to the geometrical axis of the cable body 26. As can be seen in particular from the drawing, the reinforcement 30 is offset to the side with respect to a longitudinal center plane of the toothing 32, which extends in the longitudinal direction of the cable.

In other respects, the drive cable 60 corresponds to the drive cable according to FIGS. 9 to 11.

In FIGS. 14 to 18, another embodiment of a drive cable 70 is illustrated, which also has an at least largely cylindrical cable body 26 which is provided with a toothing 32 which is formed by recesses 34 which are regularly spaced in the longitudinal direction of the cable body 26 and have a pocket-like shape. Between the recesses 34, transverse walls are formed which form tooth tips 36 whose flanks limit the recesses 34 in the longitudinal direction of the cable. In the transverse direction, the recesses 34 are limited by pocket flanks 38. With their bottoms, the recesses 34 each form a tooth root 40, which is penetrated by a reinforcement 30. The reinforcement 30 is eccentrically offset with respect to the geometrical axis of the cable body 26, namely in the direction facing away from the recesses 34. Thus, the tooth tips 36 can have a height that ensures secure engagement of the teeth of the corresponding driving gear wheel.

The tooth tips 36 have an end face that follows a cylindrical surface whose radius is smaller than the radius of the cylindrical surface that defines the circumference of the cable body 26. Thus, contact between the tooth tips 36 and a guide for the drive cable 70 is precluded.

Consequently, the tooth tips 36 of the toothing 32 have an upper limiting surface which is curved and recessed in the direction of the axis of the cable body 26 in relation to a virtual cylinder surface defined by the guiding surfaces 84.

In FIGS. 19 to 21, another embodiment of a drive cable 80 is illustrated, which differs from the embodiment according to FIGS. 14 to 18 in that it has a cable body 26 that has two flattened portions 82 in the guiding section, three guiding surfaces 84 thus being formed, whose longitudinal center planes are offset from each other by about 120°. The guiding surfaces 84 form the support of the drive cable 80 in a corresponding cable guide. Like in the embodiments described above, the guiding section has a uniform continuous cross-section in the longitudinal direction of the cable with the exception of a cable end section. The flattened portions 82 form alignment surfaces via which the drive cable 80 can align itself on a corresponding support surface of a cable guide in order for the rotational position in the installed state to be defined.

In FIGS. 22 and 23, another embodiment of a drive cable 90 is illustrated, whose cable body substantially corresponds to the cable body of the drive cable according to FIGS. 19 to 21 but differs therefrom in that it has a toothing that is realized corresponding to the toothing of the drive cable according to FIGS. 6 to 8. Additionally, the reinforcement 30 is arranged in the geometrical axis of the cable body 26.

In FIGS. 24 and 25, a drive cable 100 is illustrated that substantially corresponds to the drive cable according to FIGS. 19 to 21 but differs therefrom in that the reinforcement 30 is arranged in the geometrical axis of the cable body 26. This reduces the depth of the recesses 34 forming the toothing.

In other respects, the drive cable 100 corresponds to the drive cable according to FIGS. 19 to 21.

### REFERENCE SIGNS

10 vehicle roof
12 roof opening
14 cover element
16A, B drive slide
18A, B guide rail
20A, B drive cable
22 drive motor
24 driving gear wheel
26 cable body
28 end portion
30 reinforcement
32 toothing
34 recess
36 tooth tip
38 pocket flank
40 tooth root
42 pocket side edge
44 guiding groove
50 drive cable
52 entry track
54 entry flank
60 drive cable
70 drive cable
80 drive cable
82 flattened portion
84 guiding surface
90 drive cable
100 drive cable

1. A drive cable for actuating a vehicle element which is mobile relative to a vehicle structure, the drive cable comprising: a plastic cable body which has a toothing extending in the axial direction to become engaged with a driving gear wheel and is penetrated by a continuous reinforcement which extends in the axial direction, wherein the toothing is formed by pocket-like recesses which are regularly spaced in the axial direction and limited by flanks of resulting tooth tips in the longitudinal direction of the cable and by pocket flanks on both sides in the transverse direction of the cable and each limited at the bottom by a tooth root which is penetrated by the continuous reinforcement.

2. The drive cable according to claim 1, wherein the tooth tips of the toothing are recessed in the direction of the cable body axis with respect to a circumferential surface defined by the cable body in the tooth-free portion and virtually continuous in the toothed portion, the too thing being located entirely within the circumferential surface defined by the cable body.

3. The drive cable according to claim 1, wherein the reinforcement is arranged eccentrically with respect to a geometrical axis of the cable body.

4. The drive cable according to claim 1, wherein with respect to the circumferential direction of the cable body has an opening cross-section that takes up less than 180° in the circumferential direction of the cable body.

5. The drive cable according to claim 1, wherein each recess has pocket side edges on both sides in the transverse direction of the cable and a guiding section of the cable body extends between the two pocket side edges of a recess.

6. The drive cable according to claim 5, wherein the guiding section has at least three guiding surfaces, which are spaced apart from one another in the circumferential direction.

7. The drive cable according to claim 6, wherein the guiding surfaces have axial center lines that are offset to one another by about 120° in the circumferential direction.

8. The drive cable according to claim 1, wherein the cable body has an at least approximately circular cross-section in the area of the tooth tips.

9. The drive cable according to claim 1, wherein the cable body has an axial recess on its circumference.

10. The drive cable according to claim 8, wherein the recess is formed by a flattened portion of the cable body, by means of which the drive cable can be aligned in the circumferential direction by coming into contact with a corresponding guiding surface of a cable guide.

11. A drive cable for actuating a vehicle element which is mobile relative to a vehicle structure, the drive cable comprising a plastic cable body which has a toothing extending in the axial direction to become engaged with a driving gear wheel and is provided with a tapering end, wherein an entry track for the driving gear wheel is formed on the tapering end, the entry track extending in the longitudinal direction of the cable and being limited by entry flanks on both sides in the transverse direction of the cable and extending in the longitudinal direction of the cable up to a tooth tip of the too thing.

12. The drive cable according to claim 11, wherein the entry track has a bottom that is flush with a tooth root of the toothing.

13. The drive cable according to claim 11, wherein the entry tack is formed by a tooth root of the toothing.

14. A drive unit for a vehicle element which is mobile relative to a vehicle structure, the drive unit comprising a driving gear wheel and at least one drive cable according to claim 1.

15. The drive unit according to claim 14, wherein the drive cable and the driving gear wheel are engaged with each other across a contact line following a circular line.

16. The drive unit according to claim 15, wherein the contact line extends across at least 30° with respect to the circumference of the driving gear wheel.

17. The drive unit according to claim 16, characterized in that the driving gear wheel is engaged with two drive cables according to claim 1 and the two drive cables are offset from each other with respect to the axis of the driving gear wheel.

18. The drive unit according to claim 17, wherein each of the two drive cables is engaged with the driving gear wheel at a wrap angle of about 180°.
